(19) United States
(12) Patent Application Publication
(10) Pub. No.: US 2026/0229153 A1
(43) Pub. Date: Aug. 6, 2026

(54) DISPLAY DEVICE AND METHOD OF CONTROLLING THE SAME

(71) Applicant: LX SEMICON CO., LTD., Daejeon (KR)

(72) Inventors: JIHOON CHOI, Daejeon (KR); YOONJONG YOO, Daejeon (KR); Yongjun KIM, Daejeon (KR)

(73) Assignee: LX SEMICON CO., LTD., Daejeon (KR)

(21) Appl. No.: 19/449,024

(22) Filed: Jan. 14, 2026

(30) Foreign Application Priority Data
Feb. 4, 2025 (KR) 10-2025-0013691

(51) Int. Cl. G09G 3/00; G06T 3/40; G06T 5/80

(52) U.S. Cl. CPC G09G 3/001; G06T 3/40; G06T 5/80; G09G 2320/02; G09G 2330/021; G09G 2340/0407; G09G 2350/00; G09G 2354/00

(57) ABSTRACT

A display driver according to one embodiment of the present disclosure receives original image data with a reduced bandwidth, performs chromatic aberration correction using a first parameter related to the reduced bandwidth and a second parameter related to a distortion rate of a lens that are stored in a memory, and outputs the original image data in which the reduced bandwidth is restored to a display panel.

### CROSS-REFERENCE TO RELATED APPLICATIONS

This application claims the benefit of the Korean Patent Applications No. 10-2025-0013691 filed on Feb. 4, 2025, which are hereby incorporated by reference as if fully set forth herein.

### BACKGROUND

### Field of the Invention

Embodiments of the present disclosure directly or indirectly relate to a display driver and a display device including a lens. More specifically, for example, the embodiments are applicable to compensation technology for a display panel used in a head-mounted display (HMD), an augmented reality (AR) device, a virtual reality (VR) device, and the like.

### Discussion of the Related Art

A display panel mounted on a virtual reality (VR) device requires high resolution to implement image quality equivalent to a user's observation level in real life.

Foveated rendering display (FRD) technology applied to the VR device focuses on optimizing graphic performance by utilizing the fact that a central vision and a peripheral vision in a human's visual system process information at different resolutions.

For example, a human's eye sees the sharpest images through the fovea which is the center of the retina. The fovea has very high resolution and may detect colors and details well.

On the other hand, the peripheral vision outside the fovea has low resolution and is less sensitive to details, but is more suitable for detecting movement and large outlines.

Accordingly, FRD technology detects the user's eye movement (tracking) and tracks a gaze. Only a center region where the gaze is focused on is rendered at high resolution, and a peripheral region is rendered at relatively low resolution. Accordingly, performance and power consumption are efficiently improved by reducing the amount of graphic data to be processed.

That is, FRD technology minimizes data bandwidth through a method such as sampling or the like for data outside a region of interest while restoring input data and then sequentially applying chromatic aberration correction (CAC) to apply CAC. However, as a result, a problem in that double sampling of the input data is performed and thus image quality degrades in two stages occurs.

### SUMMARY

One embodiment of the present disclosure is directed to addressing the above-described problems of the related art and integrating chromatic aberration correction into one step without restoration/re-reduction of input image data and performing the chromatic aberration correction by reflecting processing information or the like used in foveated rendering display (FRD) technology.

Accordingly, the embodiment of the present disclosure is directed to maximally maintaining the clarity of the input image data by minimizing image quality degradation due to continuous sampling in the related art.

A method of controlling a display device including a lens according to one embodiment of the present disclosure includes receiving original image data, reducing a bandwidth of the received original image data, storing a first parameter related to the reduced bandwidth and a second parameter related to a distortion rate of the lens in a memory, performing chromatic aberration correction using the first and second parameters stored in the memory, and restoring the reduced bandwidth.

The reducing may include, for example, downsampling the original image data.

The downsampling may mean, for example, that the size of the original image data decreases from a center toward the outside.

The performing of the chromatic aberration may be, for example, performed around a region with the reduced bandwidth.

The method of controlling the display device including the lens according to one embodiment of the present disclosure may further include performing post-processing around the region with the reduced bandwidth depending on positions of a user's pupil, gaze tracking data, or whether the user is wearing glasses.

A display device including a lens according to one embodiment of the present disclosure includes a memory, a receiving module that receives original image data, and a controller that reduces a bandwidth of the received original image data, performs chromatic aberration correction using a first parameter related to the reduced bandwidth and a second parameter related to a distortion rate of the lens that are stored in the memory, and restores the reduced bandwidth.

Further, a display driver of one embodiment of the present disclosure receives original image data with a reduced bandwidth, performs chromatic aberration correction using a first parameter related to the reduced bandwidth and a second parameter related to a distortion rate of a lens that are stored in a memory, and outputs the original image data in which the reduced bandwidth is restored to a display panel.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a view schematically illustrating foveated rendering display (FRD) technology according to the related art;

FIG. 2 is a view for describing downsampling and upsampling processes of the FRD technology according to the related art;

FIGS. 3 and 4 are views for describing problems of the FRD technology according to the related art;

FIG. 5 is a block diagram schematically illustrating a display device according to one embodiment of the present disclosure;

FIG. 6 is a view illustrating the block diagram illustrated in FIG. 5 in more detail;

FIG. 7 illustrates a process in which the display device according to one embodiment of the present disclosure reduces the bandwidth of image data;

FIG. 8 illustrates a process in which the display device according to one embodiment of the present disclosure restores the bandwidth of image data;

FIG. 9 illustrates a process in which the display device according to one embodiment of the present disclosure calculates coordinate values when correcting chromatic aberration;

FIG. 10 illustrates chromatic aberration correction results according to the related art;

FIG. 11 illustrates chromatic aberration correction results according to one embodiment of the present disclosure; and

FIG. 12 is a flow chart illustrating a method of controlling the display device according to one embodiment of the present disclosure.

### DETAILED DESCRIPTION OF THE DISCLOSURE

Throughout the specification, the same reference numerals denote substantially the same components. In the following description, detailed descriptions of configurations and functions known in the technical field of the present disclosure may be omitted when not related to core components of the present disclosure. The meanings of terms described in the present specification should be understood as follows.

Advantages and features of the present disclosure and methods of achieving them will become apparent with reference to the following embodiments, which are described in detail, in conjunction with the accompanying drawings. However, the present disclosure is not limited to the embodiments to be described below and may be implemented in various different forms, the embodiments are only provided to completely disclose the present disclosure and completely convey the scope of the present disclosure to those skilled in the art, and the present disclosure is defined only by the scope of the claims.

Since the shapes, sizes, proportions, angles, numbers, and the like disclosed in the drawings for describing the embodiments of the present disclosure are only exemplary, the present disclosure is not limited to the items shown in the drawings. The same reference number indicates the same components throughout the specification. Further, in describing the present disclosure, when it is determined that a detailed description of related known technology may unnecessarily obscure the gist of the present disclosure, the detailed description thereof will be omitted.

When ‘providing,’ ‘including,’ ‘having,’ ‘consisting of,’ and the like mentioned in the present specification are used, other parts may be added unless ‘only’ is used. A case in which a component is expressed in a singular form may include a plural form unless explicitly stated otherwise.

In interpreting a component, the component is interpreted as including a margin of error even when there is no separate explicit description of the margin of error.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

In a description of a temporal relationship, when the temporal relationship is described as ‘after,’ in succession to,’ ‘and then,’ ‘before,’ or the like, non-consecutive cases may also be included unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

In should be understood that the term “at least one” includes all possible combinations from one or more related items. For example, the meaning of “at least one of the first, second, and third items” may mean any combination of items which may be proposed from two or more of the first item, the second item, and the third item, as well as each of the first item, the second item, or the third item.

Features of various embodiments of the present specification may be partially or entirely combined with each other, and technically, various linkages and operations are possible, and the embodiments may be implemented independently of each other or together in a related relationship.

Hereinafter, embodiments of the present disclosure will be described in detail with reference to the accompanying drawings.

FIG. 1 is a view schematically illustrating foveated rendering display (FRD) technology according to the related art.

FRD technology is a visual rendering technology designed to improve image quality in a currently viewed region. A device 120 to which FRD technology is applied may be, for example, a head-mounted display (HMD), an augmented reality (AR) device, a virtual reality (VR) device, or the like

The device 120 operates by mimicking the natural function of the human eye which see an object in a center of a gaze more clearly than in the peripheral field of view.

While a high-quality image is rendered in a region of interest or the like where the gaze of the viewer's two eyes 110 is focused, processing resources used to render the image are optimized when the quality of a peripheral region outside the region of interest is lowered.

Accordingly, there are performance advantages in that a frame rate increases, battery life increases, and heat generation in the head-mounted device is reduced.

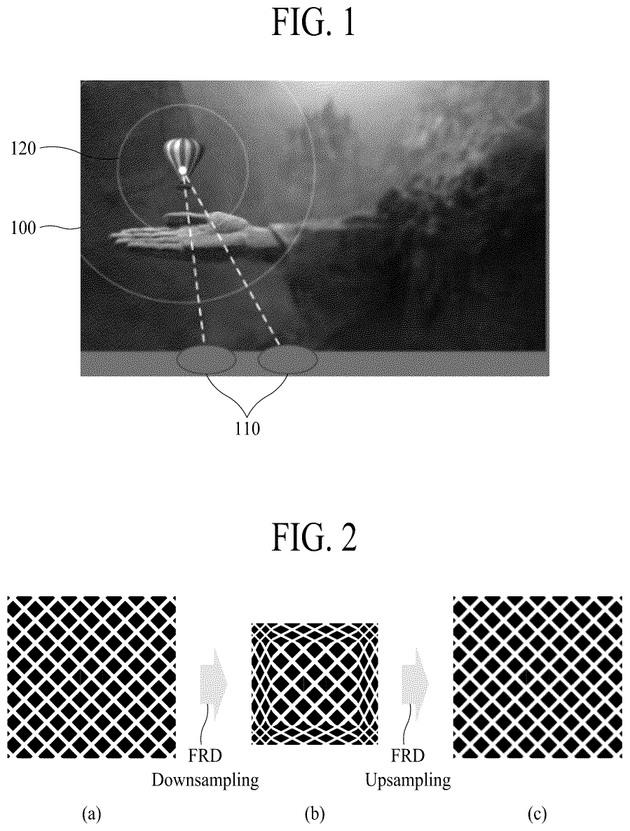

FIG. 2 is a view for describing the downsampling and upsampling processes of the FRD technology according to the related art.

FIG. 2A refers to image data received by, for example, a VR device or the like.

When the VR device downsamples the image data illustrated in FIG. 2A, the image data becomes the same as FIG. 2B. That is, as the image data is transmitted by minimizing the bandwidth of the image data outside the region of interest, an image quality level perceived by a user maintains the same level as the input image data, and high-resolution image data display is possible.

Further, when the VR device up samples the image data illustrated in FIG. 2B again, the image data becomes the same as FIG. 2C.

However, the VR device according to the related art minimizes the data bandwidth through a method such as sampling of the data outside the region of interest or the like while restoring the input data and then performing chromatic aberration correction to apply chromatic aberration correction.

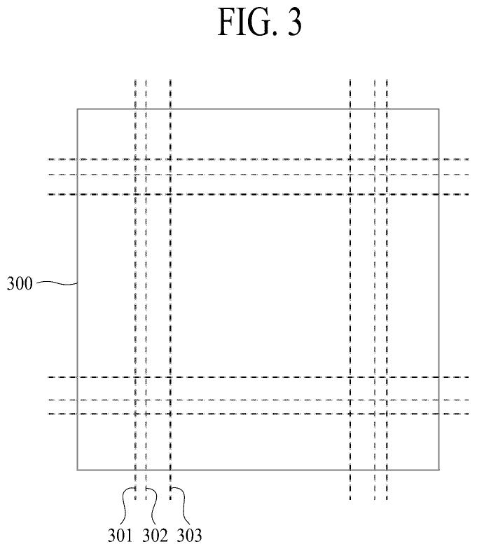

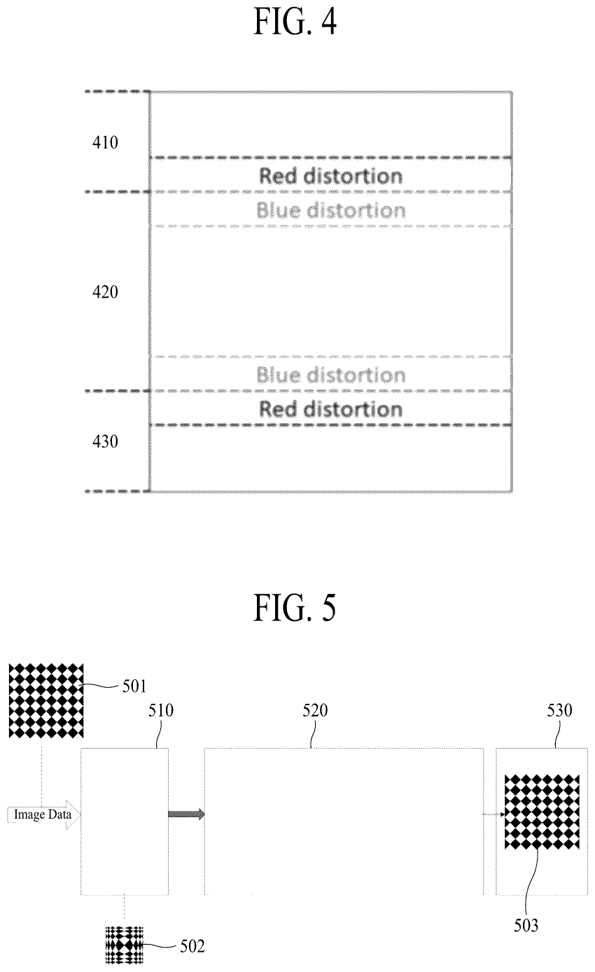

Accordingly, there was a problem in that double sampling of the input data is performed and thus image quality degrades in two stages. This will be described below in more detail with reference to FIGS. 3 and 4.

FIGS. 3 and 4 are views for describing problems of the FRD technology according to the related art.

As illustrated in FIG. 3, when FRD technology is applied to a VR device 300, since the image data of a display panel is observed through a lens, there is a problem in that different trends for red color (R) 301, green color (G) 302, and blue color (B) 303 are observed at a boundary portion of the FRD processing region and appear as artifacts.

Since the degree of compression and transmission in the FRD technology according to the related art varies depending on the region, differences in image resolution occur based on a boundary of each region.

Further, when the user observes this through the lens, since the refractive indices of R/G/B are different, artifacts which cause resolution differences occur.

Accordingly, when the same FRD technology processing is applied, resolution appears to be lower in a region where relatively low intensity FRD processing has been applied at a FRD boundary surface in the order of B, G, and R.

Further, a center region 420 in FIG. 4 refers to a region where image data is not reduced, an upper region 410 in FIG. 4 refers to a region where the image data is reduced two-fold, and a lower region 430 in FIG. 4 also refers to a region where the image data is reduced two-fold.

In this case, as illustrated in FIG. 4, red and blue artifacts occur at a boundary portion between the center region 420 and the upper region 410.

According to one embodiment of the present disclosure, when the chromatic aberration correction of the VR device is applied using FRD processing information or the like, it is integrated into one step without a restoration/re-reduction process of the input image data to minimize image quality degradation due to continuous sampling.

Various embodiments related to this will be described below in more detail in FIG. 5.

FIG. 5 is a block diagram schematically illustrating a display device according to one embodiment of the present disclosure.

In order to achieve high resolution conditions in the VR device, bandwidth reduction processing such as the above-described FRD technology is required.

However, when the FRD technology and chromatic aberration correction are simultaneously applied in the VR device by the related art, a method of restoring the reduced data to correct chromatic aberration and then reducing the restored data is applied.

However, in this case, since there is a concern that degradation repeatedly occurs in the restoration/re-reduction processes for the image data when sampling/interpolation methods are applied, one embodiment of the present disclosure minimizes image quality degradation and additionally corrects the occurrence of the artifacts in the FRD boundary region by the lens by integrating the FRD technology and chromatic aberration correction.

As illustrated in FIG. 5, the display device according to one embodiment of the present disclosure includes a controller 510, a display driver 520, and a display panel 530. Here, the controller 510 corresponds to, for example, a system on chip (SoC) or the like, and the display driver 520 corresponds to, for example, a display driver integrated circuit (DDIC) or the like.

First, the controller 510 receives original image data 501 from the outside, and the controller 510 generates image data 502 with a reduced bandwidth.

The display driver 520 receives the original image data with the reduced bandwidth from the controller 510 and performs chromatic aberration correction using a first parameter related to the reduced bandwidth and a second parameter related to a distortion rate of the lens which are stored in a memory.

Then, the display driver 520 outputs original image data 503 in which the reduced bandwidth is restored to the display panel 530.

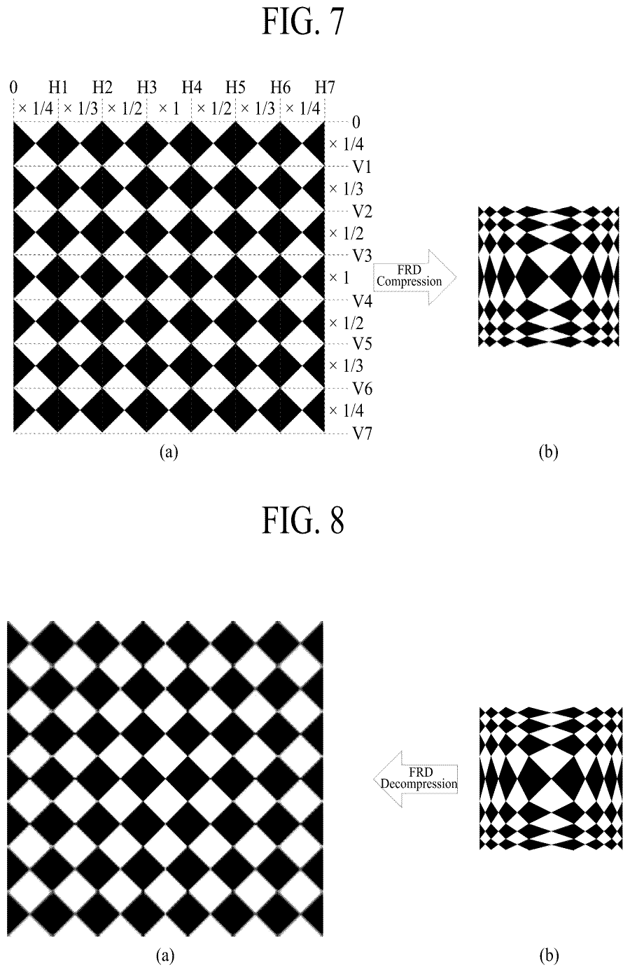

Furthermore, the display driver 520 may downsample the original image data. Here, downsampling means that the size of the original image data decreases from a center toward the outside. An embodiment related to this will be described below in FIG. 7.

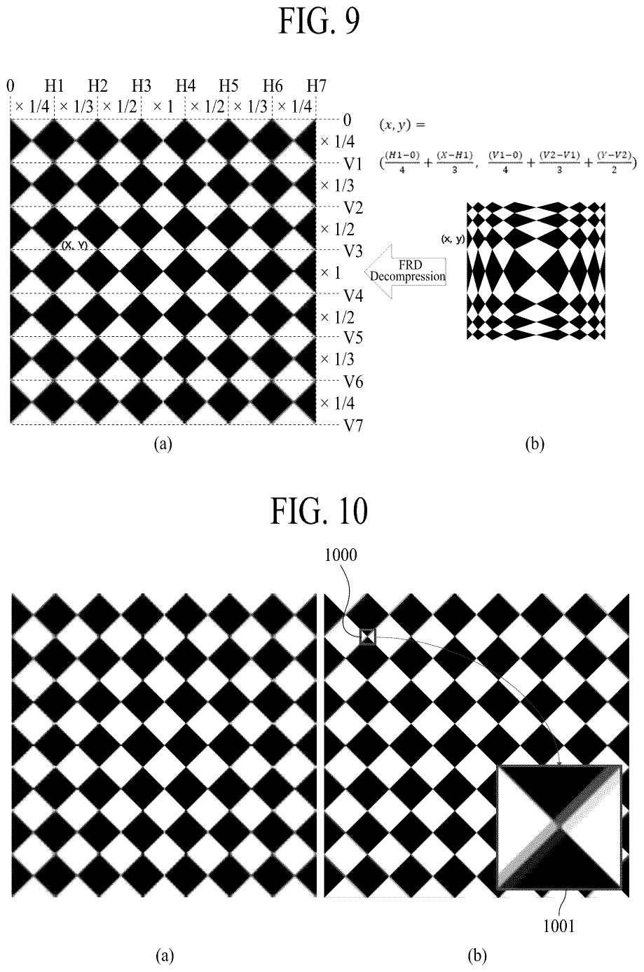

Further, the display driver 520 may further perform chromatic aberration correction around a region with a reduced bandwidth. An embodiment related to this will be described below in FIG. 9.

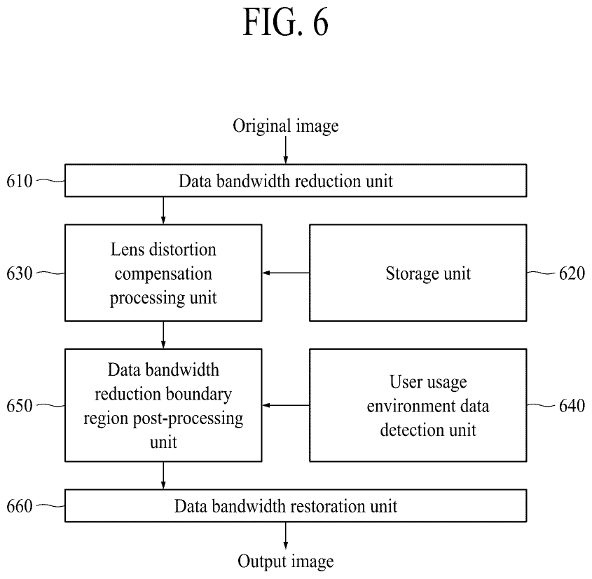

Furthermore, the display driver 520 performs post-processing around the region with the reduced bandwidth depending on positions of a user's pupil, gaze tracking data, or whether the user is wearing glasses. An embodiment related to this will be described below in FIG. 6.

Meanwhile, for reference, when performing the chromatic aberration correction, a positional relationship in which a center point of the display panel used as a reference point and the user's pupil are perpendicular to each other is not always guaranteed.

When there is an angular difference between the positions of the user's pupil and gaze and the display panel, this may lead to a difference in recognition performance at the FRD boundary surface.

Accordingly, this difference may be minimized through clarity improvement or blur processing for a color such as R, B, or the like.

Since differences may occur depending on whether the user is wearing glasses, a difference in glasses prescription, or the like, similar boundary surface post-processing may be required.

FIG. 6 is a view illustrating the block diagram illustrated in FIG. 5 in more detail.

As illustrated in FIG. 6, the display device according to one embodiment of the present disclosure includes a data bandwidth reduction unit 610, a storage unit 620, a lens distortion compensation processing unit 630, a user usage environment data detection unit 640, a data bandwidth reduction boundary region post-processing unit 650, and a data bandwidth restoration unit 660.

When the image data on the display panel is observed through a lens such as in a VR device, it is necessary to apply a technology for compensating for the chromatic aberration caused by the lens. Further, in the display panel mounted on the VR device, a high refresh rate, resolution, pixels per degree (PPD), and the like should be supported to implement image quality equivalent to a user's observation level in real life.

Furthermore, the VR device is a device which should be used while being worn by the user, and requires optimization such as minimizing power consumption or the like, including weight reduction for long-term use.

In order to minimize power consumption and maintain high resolution, FRD technology which reduces data bandwidth is used, and in order to apply the conventional chromatic aberration correction technology, a method of restoring data with a reduced bandwidth, performing chromatic aberration correction processing, and then reducing the bandwidth again is applied. When processing is performed through this process, multiple image quality degradations occur in the bandwidth restoration/re-reduction process and the chromatic aberration correction process. Further, due to unique characteristics of the VR device, when the image is observed through the lens, additional artifacts occur at the boundaries of the region where the FRD is applied.

In order to address this problem, one embodiment of the present disclosure minimizes image quality degradation and reduces the artifacts at FRD region boundaries by allowing chromatic aberration correction processing without restoration/re-reduction of the bandwidth.

The data bandwidth reduction unit 610 reduces the bandwidth of the original image data received from the outside. An embodiment related to this will be described below in more detail with reference to FIG. 7.

The storage unit 620 stores parameters or the like used when the data bandwidth is reduced to compensate for chromatic aberration without restoring the input data to which a bandwidth reduction technique such as the FRD or the like is applied to its original state, and transmits the parameters to the lens distortion compensation processing unit 630 for chromatic aberration compensation.

In this case, the storage unit 620 digitizes and stores parameters which reflect the distortion rate or the like of the lens used in the VR device, and transmits the stored parameters to the lens distortion compensation processing unit 630 so that the stored parameters may be utilized.

Meanwhile, when the image data is observed on the display of the VR device, a level of the image quality perceived by the user varies depending on the environment used by the user.

Accordingly, the user usage environment data detection unit 640 may detect various types of environmental data or the like which may cause a difference in image quality and utilize the environmental data or the like in an image quality optimization process.

The lens distortion compensation processing unit 630 performs processing using the input data with the reduced data bandwidth. However, unlike the related art, the input data required for compensation processing is determined by reflecting the bandwidth reduction parameters (stored in the storage unit 620) in lens distortion parameter information, and the image data is generated by performing a calculation process such as interpolation or the like using the input data.

Further, when observation is performed through the lens of the VR device, a performance difference occurs near the boundaries of the region with the reduced bandwidth depending on differences in R, G, and B refractive indices. The occurrence of artifacts due to the refractive indices is minimized by readjusting the compensation region based on the boundary region perceived by the user depending on R, G, and B.

Meanwhile, in a data bandwidth reduction boundary region, the FRD technology allows users to perceive image quality differently.

Accordingly, the data bandwidth reduction boundary region post-processing unit 650 performs post-processing to minimally recognize the perceived differences in the boundary region by reflecting an environment in consideration of individual differences such as positions of a user's pupil, gaze tracking data, whether the user is wearing glasses, or the like.

Further, the data bandwidth restoration unit 660 restores the input image data whose size has been reduced by the data bandwidth reduction unit 610. An embodiment related to this will be described below with reference to FIGS. 7 and 8.

Meanwhile, when summarizing and describing again, the storage unit 620 stores the first parameter related to the reduced bandwidth and the second parameter related to the distortion rate of the lens of the VR device.

Although not illustrated in FIG. 6, a receiving module (not illustrated) receives the original image data.

Meanwhile, the data bandwidth reduction unit 610 reduces the bandwidth of the received original image data, and the lens distortion compensation processing unit 630 performs chromatic aberration correction using the first parameter related to the reduced bandwidth and the second parameter related to the distortion rate of the lens which are stored in the storage unit 620. Further, the data bandwidth restoration unit 660 restores the reduced bandwidth. It is also possible to implement the above-described data bandwidth reduction unit 610, lens distortion compensation processing unit 630, and data bandwidth restoration unit 660 as one controller.

FIG. 7 illustrates a process in which the display device according to one embodiment of the present disclosure reduces the bandwidth of the image data.

First, it is assumed that the display device (for example, the VR device or the like) according to one embodiment of the present disclosure has received the original image data illustrated in FIG. 7A.

In this case, when FRD compression is performed, the bandwidth of the original image data is reduced, and as illustrated in FIG. 7B, some regions of the original image data are reduced.

For example, in a horizontal direction, the image data is reduced to a ¼ size between 0 and H1 and between H6 and H7. Furthermore, in the horizontal direction, the image data is reduced to a ⅓ size between H1 and H2 and between H5 and H6.

Further, in the horizontal direction, the image data is reduced to a ½ size between H2 and H3 and between H4 and H5. On the other hand, in the horizontal direction, the size of the original image data is maintained between H3 and H4. The corresponding region may be assumed to be a region of interest (ROI).

Meanwhile, in a vertical direction, the image data is reduced to a ¼ size between 0 and V1 and between V6 and V7. Furthermore, in the vertical direction, the image data is reduced to a ⅓ size between V1 and V2 and between V5 and V6.

Further, in the vertical direction, the image data is reduced to a ½ size between V2 and V3 and between V4 and V5. On the other hand, in the vertical direction, the size of the original image data is maintained between V3 and V4. The corresponding region may be assumed to be a region of interest (ROI).

FIG. 8 illustrates a process in which the display device according to one embodiment of the present disclosure restores the bandwidth of the image data

First, FIG. 8B refers to the image data with the reduced bandwidth and corresponds to FIG. 7B.

In this case, when FRD decompression is performed, the image data is restored to its original size as illustrated in FIG. 8A.

Meanwhile, according to the related art, both the process illustrated in FIG. 7 and the process illustrated in FIG. 8 should be performed to correct chromatic aberration. However, in this case, there was a problem of image quality degradation.

In order to address this, according to one embodiment of the present disclosure, as illustrated in FIG. 7B, the chromatic aberration correction is designed to be performed on the image data with the reduced bandwidth.

However, in order to perform chromatic aberration correction on the image data with the reduced bandwidth, coordinates should be found using parameters related to bandwidth reduction. An embodiment related to this will be described below in FIG. 9.

FIG. 9 illustrates a process in which the display device according to one embodiment of the present disclosure calculates coordinate values when chromatic aberration is corrected.

Chromatic aberration correction is performed on the image data with the reduced bandwidth (FIG. 9B). According to one embodiment of the present disclosure, a region where performance is enhanced is a region where reduction is achieved in an FRD process. For example, the region where performance is enhanced may include a boundary between a region where the resolution of the input image is maintained and the reduced region.

FIG. 9 illustrates a calculation formula of image coordinate values when the image data with the reduced bandwidth is restored to its original resolution based on the image data with the reduced bandwidth due to FRD processing.

However, in order to implement this, the parameters used to reduce the bandwidth of the original image data should be stored in the memory.

FIG. 9A is a view showing image data with degraded performance after the FRD-processed image data is restored (decompressed) to its original resolution, and (X, Y) represents a point where chromatic aberration correction is performed at an original image resolution.

On the other hand, (x, y) represents the point where chromatic aberration correction is performed in the FRD reduced data.

Further, (x, y) is acquired by the following Equation 1.

$$( x , y ) = ( ( H 1 - 0 ) / 4 + ( X - H 1 ) / 3 , ( V 1 - 0 ) / 4 + ( V 2 - V 1 ) / 3 + ( Y - V 2 ) / 2 ) \qquad [ Equation 1 ]$$

Here, H1, V1, V2, and the like are illustrated in FIG. 9A, and may represent parameters related to bandwidth reduction.

FIG. 10 illustrates chromatic aberration correction results according to the related art.

According to the related art, in order to correct chromatic aberration in image data whose bandwidth has been reduced by FRD technology or the like, the image data with the reduced bandwidth is restored as illustrated in FIG. 10A.

Further, since chromatic aberration correction is performed on the restored image data, there is a problem that a region 1001 where a color is blurred occurs at an arbitrary point 1000 illustrated in FIG. 10B.

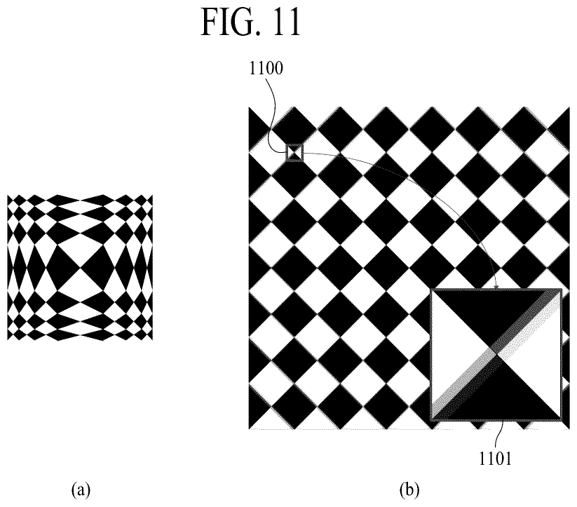

FIG. 11 illustrates chromatic aberration correction results according to one embodiment of the present disclosure.

On the other hand, according to one embodiment of the present disclosure, in order to correct chromatic aberration in image data whose bandwidth has been reduced by FRD technology or the like, the image data with the reduced bandwidth is used as is, as illustrated in FIG. 11A.

Further, since parameter information related to bandwidth reduction stored in the memory is used, only a region 1101 where a color is clear is shown at an arbitrary point 1100 illustrated in FIG. 11B.

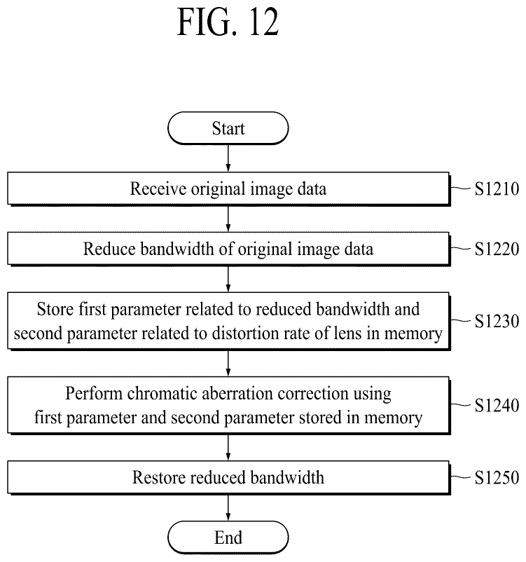

In addition, FIG. 12 is a flowchart illustrating a method of controlling the display device according to one embodiment of the present disclosure.

A display device (for example, a VR device, or the like) including a lens according to one embodiment of the present disclosure receives original image data (S1210).

Furthermore, the display device reduces the bandwidth of the received original image data (S1220). An embodiment related to this has been previously described in FIG. 7.

Further, the display device stores a first parameter related to the reduced bandwidth and a second parameter related to a distortion rate of the lens in the memory (S1230).

In addition, the display device performs chromatic aberration correction using the first parameter and the second parameter stored in the memory (S1240).

In addition, the display device restores the reduced bandwidth (S1250).

Operation S1220 may downsample the original image data. Here, downsampling means, for example, that the size of the original image data decreases from a center toward the outside. An embodiment related to this has been previously described in FIG. 7.

Operation S1240 is performed around the region with the reduced bandwidth. An embodiment related to this has been previously described in FIG. 9.

Further, although not illustrated in FIG. 12, the display device performs post-processing around the region with the reduced bandwidth depending on positions of a user's pupil, gaze tracking data, or whether the user is wearing glasses.

Those skilled in the art may understand that the present disclosure described above may be implemented in other specific forms without changing the technical spirit or essential characteristics thereof.

Further, the methods described in the present specification may be implemented by at least partially using one or more computer programs or components. The components may be provided as a series of computer instructions through a computer-readable medium or machine-readable medium including volatile and non-volatile memories. The instructions may be provided as software or firmware and implemented entirely or partially on hardware components such as application-specific integrated circuits (ASICs), field-programmable gate arrays (FPGAs), digital signal processors (DSPs), or other similar elements. The instructions may be configured to be executed by one or more processors or other hardware components, and the processors or other hardware components may perform or allow performing all or part of the methods and procedures disclosed in the present specification when the series of computer instructions are executed.

According to one embodiment of the present disclosure, there is a technical effect in that image quality degradation can be reduced and the clarity of input image data can be maximally maintained by reflecting processing information or the like used in foveated rendering display (FRD) technology to integrate chromatic aberration correction into one operation without restoration/re-reduction of the input image data and perform the chromatic aberration correction.

Furthermore, there is an advantage in that RGB artifacts are removed in consideration of performance differences depending on a lens mounted on a virtual reality (VR) device.

Further, in addition to the effects of the invention explicitly disclosed herein, other technical effects that can be inferred by those skilled in the art from the specification and the drawings may also be within the scope of the present disclosure.

Accordingly, it should be understood that the above-described embodiments are illustrative and not restrictive in all respects. Further, the scope of the present disclosure is shown by the appended claims rather than the above-described detailed description, and all changes or modifications derived from the meaning and the scope of the claims and equivalents thereof should be understood as being included in the scope of the present disclosure.

What is claimed is:

1. A method of controlling a display device including a lens, the method comprising:
receiving original image data;
reducing a bandwidth of the received original image data;
storing a first parameter related to the reduced bandwidth and a second parameter related to a distortion rate of the lens in a memory;
performing chromatic aberration correction using the first and second parameters stored in the memory; and
restoring the reduced bandwidth.

2. The method of claim 1, wherein the reducing includes downsampling the original image data.

3. The method of claim 2, wherein the downsampling means that a size of the original image data decreases from a center toward the outside.

4. The method of claim 1, wherein the performing of the chromatic aberration correction is performed around a region with the reduced bandwidth.

5. The method of claim 4, further comprising performing post-processing around the region with the reduced bandwidth depending on positions of a user's pupil, gaze tracking data, or whether the user is wearing glasses.

6. A display device including a lens, comprising:
a memory;
a receiving module that receives original image data; and
a controller that reduces a bandwidth of the received original image data, performs chromatic aberration correction using a first parameter related to the reduced bandwidth and a second parameter related to a distortion rate of the lens that are stored in the memory, and restores the reduced bandwidth.

7. The display device of claim 6, wherein the controller downsamples the original image data.

8. The display device of claim 7, wherein the downsampling means that a size of the original image data decreases from a center toward the outside.

9. The display device of claim 6, wherein the controller performs the chromatic aberration correction around a region with the reduced bandwidth.

10. The display device of claim 9, wherein the controller performs post-processing around the region with the reduced bandwidth depending on positions of a user's pupil, gaze tracking data, or whether the user is wearing glasses.

11. A display driver that receives original image data with a reduced bandwidth, performs chromatic aberration correction using a first parameter related to the reduced bandwidth and a second parameter related to a distortion rate of a lens that are stored in a memory, and outputs the original image data in which the reduced bandwidth is restored to a display panel.

12. The display driver of claim 11, wherein the display driver downsamples the original image data.

13. The display driver of claim 12, wherein the downsampling means that a size of the original image data decreases from a center toward the outside.

14. The display driver of claim 11, wherein the display driver performs the chromatic aberration correction around a region with the reduced bandwidth.

15. The display driver of claim 14, wherein the display driver performs post-processing around the region with the reduced bandwidth depending on positions of a user's pupil, gaze tracking data, or whether the user is wearing glasses.
